(19) United States
(12) Patent Application Publication
(10) Pub. No.: US 2025/0034005 A1
(43) Pub. Date: Jan. 30, 2025

(54) CONTAMINANT TRANSFORMATION AND STABILIZATION SYSTEM

(71) Applicant: TRUCLEAR WATER SOLUTIONS, INC., Abilene, TX (US)

(72) Inventors: John Ayers, Albany, TX (US); Patrick Doggett, Austin, TX (US)

(21) Appl. No.: 18/710,836

(22) PCT Filed: Nov. 15, 2022
(86) PCT No.: PCT/US22/79897

§ 371 Date: May 16, 2024

Related U.S. Application Data
(60) Provisional application No. 63/279,966, filed on Nov. 16, 2021.

(51) Int. Cl. C02F 1/461

(52) U.S. Cl. CPC C02F 1/46109; C02F 2001/46161; C02F 2001/46171

(57) ABSTRACT

A fluid activation system including an inlet line configured to receive raw water, a pump fluidly coupled to the inlet line to generate a flow through the inlet line, and a vessel fluidly coupled to the inlet line. The vessel has a reaction chamber with a flow control device and non-donating electrodes that are disposed inside the reaction chamber. The non-donating electrodes define at least one cathode electrode and at least one anode electrode to treat the raw water to produce treated water. Each of the non-donating electrodes has an electrode post. The system also includes an outlet line in fluid connection with the vessel, and a power distribution system that is electrically connected to the electrode posts to power the non-donating electrodes.

### CROSS-REFERENCE TO RELATED APPLICATIONS

This application is a national stage filing under 35 U.S.C. § 371 of International Patent Application No. PCT/US2022/079897, filed on Nov. 15, 2022, which claims priority to U.S. Provisional Patent Application No. 63/279,966, filed on Nov. 16, 2021, the entire contents of each of which are incorporated herein by reference.

### BACKGROUND

The present application relates to a system that transforms and stabilizes contaminants in a fluid and, more particularly, to a system that transforms and stabilizes contaminants using a process that does not require added chemicals.

In conventional practice, raw water is cleaned through the addition of chemicals and additives to flocculate the contaminates. The flocculant containing the contaminants requires physical removal from the system. This method of pollutant removal from the water leaves the water laden with myriad of chemicals, some of which may be hazardous. Disposal of this water must follow rigorous regulations. Other treatment systems use ozone that is produced by separate generators, which create microbubbles that float up through the raw water. The ozone oxidizes some contaminants and flocculates them to the surface for physical removal. The ozone kills bacteria, but ozone-based treatment systems do not significantly affect heavy metals or contaminate compounds such as hydrogen sulfide (H₂S). In addition, existing ozone systems rely on dwell time and cannot clean high volumes of raw water.

Another existing approach to treat water uses electrochemistry and chlorine and chlorine dioxide. This treatment approach uses low amperage electrical current (e.g., with electrode current densities of 30 to 50 mA/cm² for electrolysis-based systems) that is applied to donating electrodes and, in a separate electrochemical process, ultrapure water and sodium chloride to generate chlorine and chlorine dioxide. The chlorine mixture is slipstreamed into raw water to kill bacteria. However, these electrolysis-based systems do not effectively treat any of chemical contaminants in the water. These systems use donating electrodes, which breakdown and introduce new dissolved metals from the electrodes into the treated water. Therefore, current densities must be limited in these types of systems to keep the electrodes from disintegrating. In addition, existing systems cannot adequately accommodate a high current density multi-electrode arrangement in a closed chamber without detrimental overheating.

These existing systems provide solutions that may produce water that looks clean, but undesirable levels of contamination remain from these chemicals. In addition, these systems generate a significant waste stream that requires dewatering and shipping sludge and solids to a hazardous waste disposal facility.

### SUMMARY

In one aspect, the invention includes a scalable fluid treatment system that is free of chemical additives and is energy efficient. The fluid treatment system includes a series of reaction chambers in a treatment unit, a power distribution system, and a loop reactor including a mixing and pre-reaction vessel (referred to in the detailed description to as the “mix vessel”). The fluid treatment system uses electrochemistry to produce chemicals which kill bacteria and treat contaminants without the addition of third-party chemicals (either directly or as a catalyst) and is energy and waste efficient.

The treatment system can treat multiple types of raw water through the series of reaction chambers housing non-donating electrodes. The treatment unit transforms and stabilizes contaminates into other less contaminating compounds and ions without generating a waste stream. Non-donating electrodes within each reaction chamber facilitate electrolysis and advanced molecular oxidation. Reduction-oxidation reactions within the reaction chambers breakdown and neutralize contaminants. Raw water can be recirculated or looped through a series of reaction chambers until desired treatment parameters for treated water are reached. Treated water leaving the reaction chambers is defined as activated fluid because the fluid can subsequently treat contaminant substances in raw or non-activated water as it enters the loop reactor in the mixing and pre-reaction vessel. Raw water mixed with activated fluid is treated via activated species in the activated fluid.

The power necessary to induce electrolysis and reduction-oxidation reactions and achieve desired treatment parameters is supplied to each reaction chamber by the heat-controlled power distribution system. Factors that contribute to overheating in enclosed electrolysis reactions include spacing between the electrodes, differences in the surface area of each electrode, and the material forming the electrodes and the electrical terminal connections that transfer the current between the power supply and the electrodes. In tightly spaced electrodes, there is a higher heating potential of the associated power distribution system. Also, in a daisy-chain arrangement for power connections, resistive heating can become an issue. For example, a wire connects the rectifier to the first positive electrode, and a second wire runs between the first and second positive electrode. A third wire runs between the second and third positive electrodes connecting all the positive electrodes to power. The system repeats the same process for the negative electrodes with the ground wire. The inventors of the system embodied herein recognized that this results in loops of positive and negative electrical cables, which may add to the resistance-heating effect, and the terminal lugs on each end of the wires may cause additional resistance-heating.

The inventors of the system embodied herein also recognized that, because the electrodes are concentrically arranged in the reaction chamber, the size difference (i.e. surface area) of each electrode causes differences in resistance for each electrode. For example, the resistance of the outside (larger) electrode is greater than the resistance of the inside (smaller) electrode. Another resistive-heating issue recognized by the inventors and addressed by the system embodied herein relates to differences in the materials used for the electrodes and the connections used to transfer the current from the wire to the electrode.

The treatment system embodied in the invention described and illustrated herein accounts for the higher heating potential caused by daisy-chain connections and other resistive heating issues noted above. In one example, the fluid treatment system includes a bar (e.g., copper) that is connected to each electrode post rather than daisy chain wires between electrodes. Additionally, resistive-heating caused by the connectors or electrode posts is addressed by manufacturing the posts and the electrode mesh from the same grade metal, and each post is coated with the same material as the electrode mesh.

The treatment system, which breaks down contaminants though electrochemical reactions in the treatment unit, is part of a loop reactor which includes a mix vessel fluidly connected to the treatment unit. The loop reactor and fluid connection between the treatment unit and the mix vessel facilitates the treatment of inflowing raw water through activated water from the reaction chambers. The mix vessel includes inlets for both raw water and activated water from the reaction chambers, and outlets for storing treated water and recirculating the reactant supply of treated water back to the reaction chamber. The mix vessel also includes jets and jet tubing to generate turbulence to mix raw water that enters the vessel and activated fluid that is circulated from the reaction chambers to the mix vessel. The turbulence generated by the jets provide adequate mixing and the reaction kinetics necessary to initiate reactions that breakdown the contaminants in the inflowing raw water.

In some embodiments, the loop reactor provides continuous recirculation where untreated water enters, mixes with activated water, and treated water exits. For example, a portion of the treated water exiting the mix vessel is returned to the treatment unit. The supply of activated water (reactant supply) entering the mix vessel to treat inflowing raw water is continuously returned to the mix vessel where new raw water is introduced. The activated water treats water entering the vessel as it moves from one end to the other. This water circulation in the mix vessel provides mixing and reaction time to allow for a range of reaction kinetics for disinfection and transformation in a steady-state operation. In some embodiments, the treatment parameters for activated water entering the mix vessel from the reaction chambers are higher than the treatment parameters for treated water exiting the mix vessel for storage.

The treatment system breaks down contaminates from complex compounds and reduces particulate size through electrochemistry and reduction-oxidation reactions in the treatment unit and mix vessel. Treated water moves out of the mix vessel at a controlled rate equal to the rate the untreated or raw water enters the loop reactor, which maintains a steady state of reactor control and conversion. The loop reactor design provides a substantially constant flow rate with consistent upper and lower control limits within the reaction zone because the loop reactor allows system flow to be managed and controlled at each inlet and outlet of the treatment unit and at each inlet and outlet of the mix vessel. In addition, the loop reactor design can provide needed zones for reaction kinetics of multiple species for the transformation of specific elements. The system also provides treatment and breakdown of complex contaminants and increases treatment output volumes (e.g. yields) by twenty (20%) to forty (40%) percent, or more, relative to existing systems.

The fluid treatment system can be used to treat raw water from different sources and industries. For example, the water treatment system can be used to treat oil and gas produced and flow-back water, mining water, industrial water, landfill leachate, brackish water, seawater, fresh water, wastewater, or municipal water. The fluid treatment system creates a sustainable approach to water treatment and requires no additional chemicals. The system has an energy efficient process to provide the electrochemistry needed to produce oxygen species, chlorine species, and hydroxyl functional groups, which generates a biocide treatment that efficaciously kills bacteria as well as reducing levels of other contaminates.

Using industry standard third-party testing, the system has shown molecular bond disassociation, reduction, and transformation of contaminates like hydrogen sulfide (H₂S), iron, boron, barium, strontium, lithium, and phosphates. The system also shows a reduction in the particle size distribution. The system does not produce a waste stream and can treat over 4,200,000 gallons per day from a single 40-foot treatment unit with 24 reaction chamber platforms.

### BRIEF DESCRIPTION OF THE DRAWINGS

The aspects and features of various exemplary embodiments will be more apparent from the description of those exemplary embodiments taken with reference to the accompanying drawings.

FIG. 1 is a schematic of a fluid treatment system embodying the invention, including the treatment unit and mix vessel.

FIG. 2 is a schematic of another fluid treatment system embodying the invention, including the mixing and pre-reaction vessel.

FIG. 3 is a schematic of the treatment unit including a plurality of platforms or skids supporting a plurality of reaction chambers.

FIG. 4 is a perspective view of a treatment unit including the reaction chambers and the power distribution system.

FIG. 5 is a perspective view of one platform including serially connected reaction chambers.

FIG. 6 is a top view of the loop reactor platform of FIG. 5.

FIG. 7A is a perspective view of a portion of one reaction chamber illustrating electrode posts and bus bar connected to the electrode posts.

FIG. 7B is a top perspective view of a portion of one reaction chamber with the cover removed illustrating the interior of the reaction chamber.

FIG. 8 is a chart illustrating particle size distributions in water prior to treatment and after treatment.

FIG. 9 is a chart illustrating the oxidation reduction potential (ORP) of post-treated or activated water.

FIG. 10 is a chart illustrating hydrogen sulfide (H₂S) levels prior to water treatment and after water treatment.

FIG. 11A is a chart illustrating results of an adenosine triphosphate (ATP) test of water before and after treatment over a three-day period.

FIG. 11B is an enlargement of the chart of FIG. 11A illustrating the results of the ATP test.

FIG. 12 is a chart illustrating results of a corrosion test before and after water treatment over a three-day period.

FIG. 13A is a chart illustrating results of a turbidity and geochemistry test before and after water treatment over a three-day period.

FIG. 13B is a side view of water prior to treatment, during treatment, and after treatment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

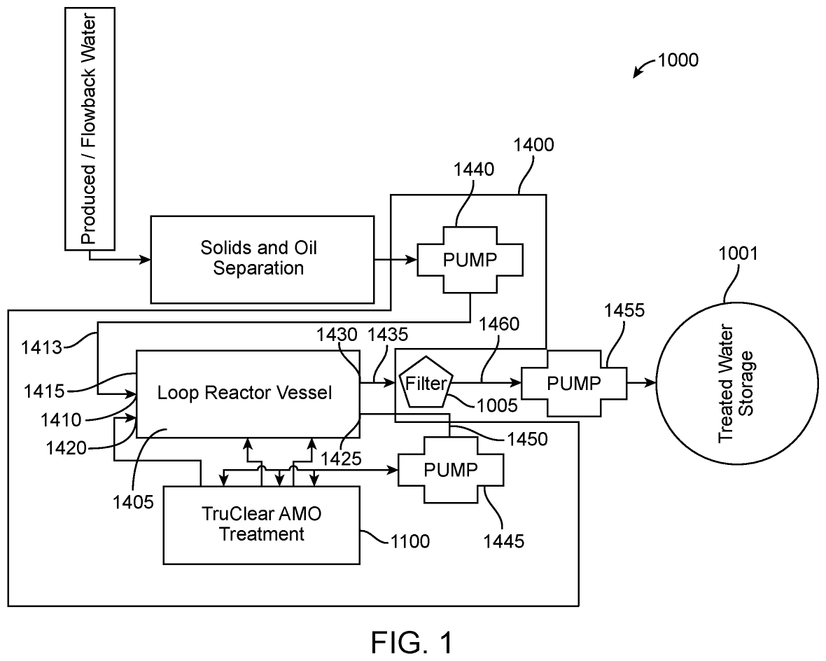

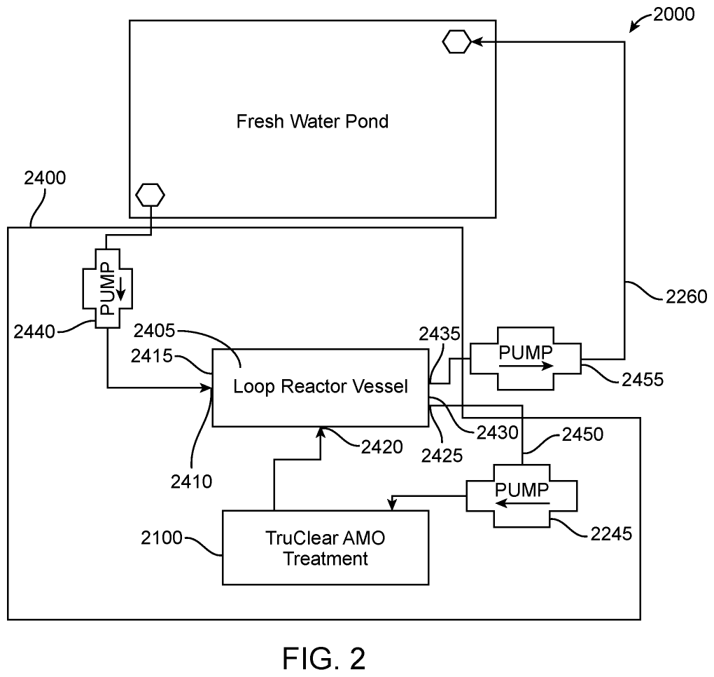

FIG. 1 illustrates an exemplary fluid treatment system 1000, also referred to as Advanced Molecular Oxidation™, for treatment of industrial, municipal, or similar aqueous fluids (e.g., oil or gas produced water and flow-back water, mining water, industrial cooling tower water, landfill leachate, brackish water, seawater, fresh water, wastewater, municipal water, polyfluoroalkyl substances (PFAS), estradiol and pharmaceutical raw water etc.). The fluid treatment system 1000 includes a treatment unit 1100 that treats and activates contaminated or raw water via electrochemistry, which creates reactive species. The fluid treatment system 1000 also includes a loop reactor 1400 that has a mix vessel 1405, a first pump assembly 1440 (e.g., one or more pumps) that moves raw water to the mix vessel 1405, a second pump assembly 1445 that moves partially activated or treated water from the mix vessel 1405 to the treatment unit 1100, and a third pump assembly 1455 that moves treated water to a downstream location 1001 (e.g., a treated water storage system or tank). As shown in FIG. 1, the fluid treatment system 1000 can include a filter 1005 between the mix vessel 1405 and the downstream location 1001. The fluid treatment system 1000 shown in FIG. 1 can be used for raw water that typically contains oil and/or solids, although the system may be used to treat fluids without either oil or solids. FIG. 2 illustrates another exemplary fluid treatment system 2000 that is similar to the fluid treatment system 1000 of FIG. 1 and that can be used to treat fluid (e.g. freshwater) stored in a pond 2001 (e.g., a freshwater pond).

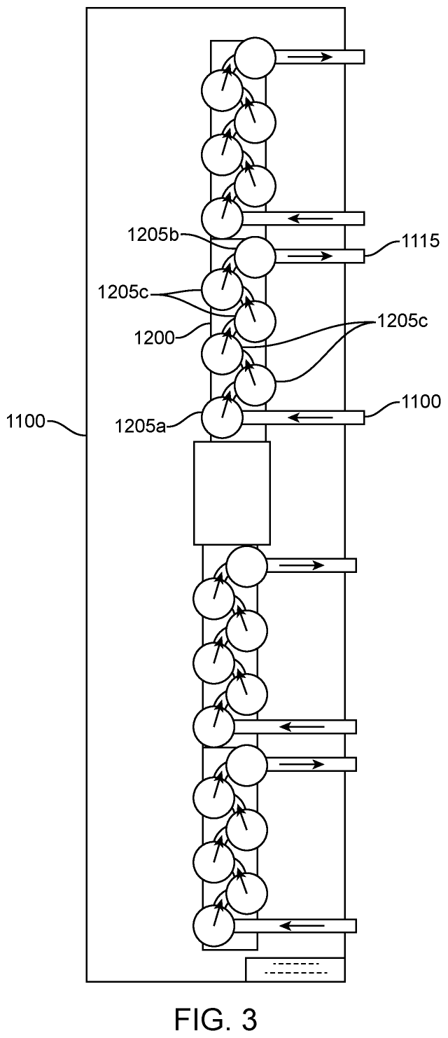

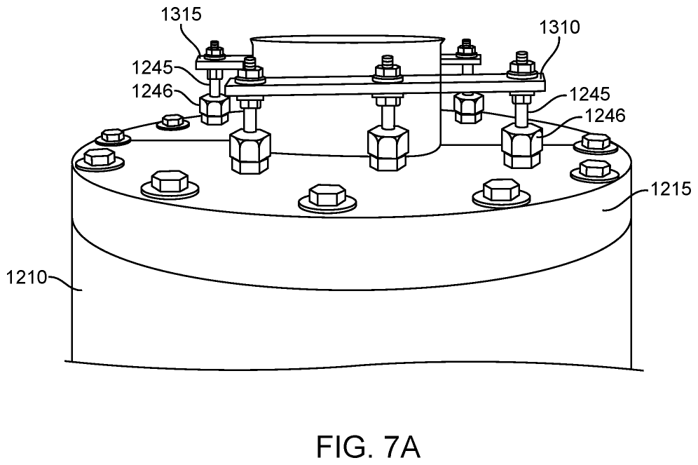

With reference to FIGS. 3-6, the treatment unit 1100 includes one or more platforms or skids 1200 (e.g., referred to as a reactor platform) that supports a plurality of reaction chambers 1205. As shown in FIG. 3, the exemplary treatment unit includes four reactor platforms 1200 that are connected in parallel to the second pump assembly 1445 via a header and respective inlet lines 1110, and that are connected to the mix vessel 1405 in parallel via respective outlet lines 1115. It will be appreciated that the treatment unit 1100 may include fewer or more than four reactor platforms 1200 depending on the amount of fluid to be treated. Each illustrated reactor platform 1200 includes six reaction chambers 1205 that are fluidly connected in series to each other, although each reactor platform 1200 may include fewer or more than six reaction chambers 1205 (e.g., two reaction chambers).

FIGS. 3, 5, and 6 show one reactor platform 1200 that supports a plurality of reaction chambers 1205 (e.g., six reaction chambers) that are fluidly connected in series to each other. As illustrated, the reactor platform 1200 includes a first or intake reaction chamber 1205a that is connected to the inlet line 1110, and a terminal or output reaction chamber 1205b that is connected to the outlet line 1115. Additional reaction chambers 1205c are serially connected between the intake reaction chamber 1205a and the output reaction chamber 1205b.

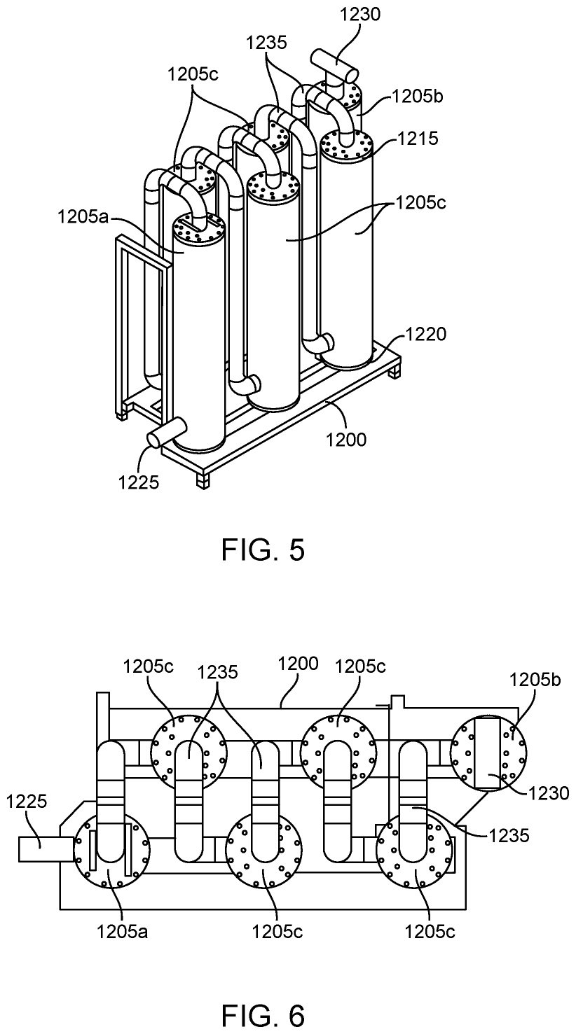

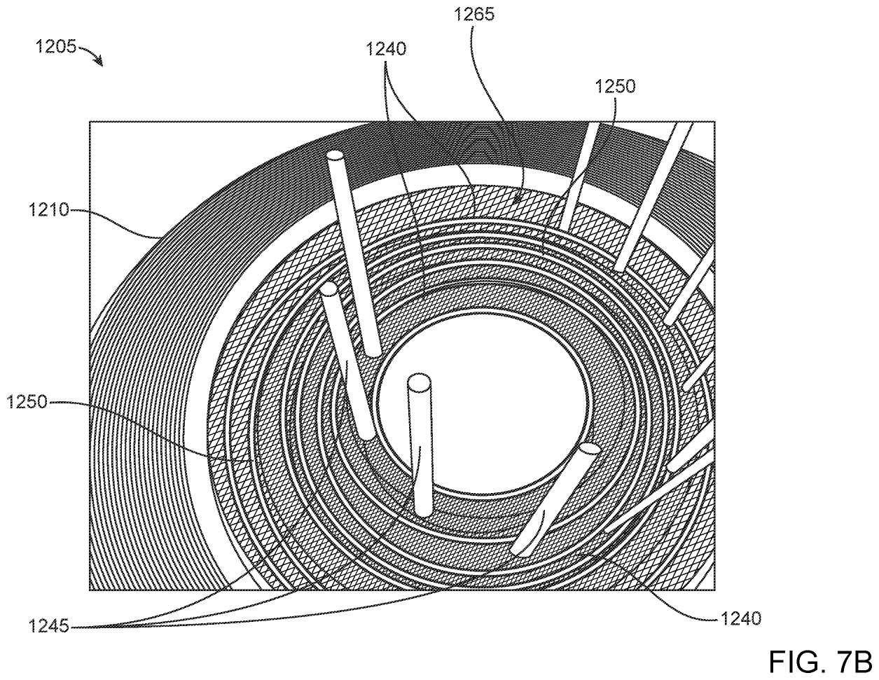

With reference primarily to FIGS. 5 and 7A, each reaction chamber 1205 has a housing 1210 or container with a cover 1215 and a base 1220 located opposite the cover 1215. Each of the cover 1215 and the base 1220 may be formed monolithically with the housing 1210 (e.g., by welding or other manufacturing processes), or bolted or otherwise fastened to the housing 1210 with a suitable fastener (e.g., compression rings, bolts, etc.). The housing 1210, cover 1215, and base 1220 are non-conductive and may be formed of high-density polyethylene (HDPE). In some constructions, the housing 1210 is operable within a temperature range of −40° C. to 120° C. In one example, the housing 1210, cover 1215, and base 1220 form a cylindrical reaction chamber 1205 with a diameter ranging from 12 inches to 36 inches. In other examples, each reaction chamber 1205 may have a height ranging between 36 inches to 60 inches, and each reaction chamber may have non-cylindrical shapes.

Each reaction chamber 1205 includes an inlet port 1225 to receive fluid either from the inlet line 1110 or from an upstream reaction chamber, and an outlet port 1230 to deliver fluid either to the outlet line 1115 or to a downstream reaction chamber. As illustrated, the inlet port 1225 is located adjacent or at the base 1220 of the housing 1210, and the outlet port 1230 is located at or adjacent the cover 1215 (e.g., extending through the cover) of the housing 1210. The inlet ports 1225 and the outlet ports 1230 of adjacent reaction chambers 1205 are connected via pipes 1235. With reference to FIG. 7A, each reaction chamber 1205 includes non-donating electrodes 1240 and electrode power posts 1245 or terminals that extend through the cover 1215. Each of the reaction chambers 1205 may also include a drain to facilitate emptying the reaction chambers 1205 when desired or necessary.

The pipes 1235 may be constructed from high-density polyethylene (e.g., HDPE). The diameter of the pipes 1235 may be selected based on the amount of fluid flow desired within the fluid treatment system 1000 (e.g., between approximately 1 inch and approximately 12 inches in diameter). In one example, the diameter of the pipes 1235 may be 4 inches. In other examples, the diameter of the pipes 1235 may be larger than 12 inches.

FIG. 7B illustrates a portion of one reaction chamber 1205 with the cover 1215 removed for clarity to expose components inside the reaction chamber 1205. The reaction chamber 1205 supports electrodes 1240 that each have a power post 1245 affixed to them for current transfer from the power distribution system 1300 to the electrode 1240. In the illustrated example, the electrodes 1240 are concentrically arranged within the reaction chamber 1205. As shown, the illustrated electrodes 1240 have a tubular or cylindrical body. It will be appreciated that the electrodes 1240 may have other arrangements within the reaction chamber 1205, and that the shape of the electrodes 1240 may depend, at least in part, on the shape of the reaction chamber 1205.

Each of the electrodes 1240 has a body that is coated to define a non-donating electrode. “Non-donating” means that the electrodes do not ‘dissolve” or lose mass, or at least only lose minimal mass, during use. As shown in FIG. 7A, an electrode seal fitting 1246 wraps around the power post 1245 and abuts the cover 1215. The electrode seal fitting 1246 seals the electrode post 1245 relative to the cover 1215 to prevent leakage. The electrode seal fitting 1246 can be formed from HDPE, metal, vinyl, UMHW (ultra-high molecular weight polyethylene), or any other suitable material.

As shown in FIG. 7B, the reaction chamber 1205 houses a flow control device 1250 that is positioned between adjacent electrodes 1240 to facilitate flow within and through the reaction chamber 1205 and to insulate adjacent electrodes 1240. More specifically, the flow control device 1250 is constructed from a non-conductive or insulative material (e.g., rubber or other non-conductive material). In the illustrated concentric arrangement of the electrodes 1240, the flow control device 1250 maintains space between electrodes 1240 to avoid contact between the electrodes. The control device 1250 can be permanently affixed to each adjacent electrode or remain unattached.

In the illustrated concentric arrangement of the electrodes 1240, the outermost electrode 1240 has the largest surface area relative to the other electrodes 1240, and the innermost electrode 1240 has the smallest relative surface area. Each electrode 1240 in the illustrated example is formed of a metallic mesh 1265 with a surface pattern that maximizes contact area. The metallic mesh 1265 may be formed in an overlapping diamond pattern or “Z” mesh, although the mesh may have other patterns or non-patterns. In the overlapping diamond pattern example, each diamond portion overlaps a portion of an adjacent diamond portion. The resulting mesh is ridged or non-planar (i.e. not smooth in the vertical direction of the reaction chamber 1205).

In one non-limiting example, each reaction chamber 1205 includes three anode electrodes and three cathode electrodes. The electrodes 1240 are arranged within the housing 1210 so that each anode electrode and cathode electrode are alternatingly arranged with the anode electrode positioned adjacent to at least one cathode electrode. Likewise, each cathode electrode is positioned adjacent to at least one anode electrode. Each of the electrodes 1240 is spaced apart from adjacent electrodes (e.g., in a range between approximately 3 mm and 10 mm). In some constructions, the spacing between the electrodes 1240 takes into account one or more of the coating material on the electrode 1240, the conductivity of the electrode 1240, and conductivity of the fluid. In some constructions, each electrode 1240 can support current densities of 75 mA/cm² to over 1,000 mA/cm² for extended running periods to facilitate treatment of raw water at high flow rates (e.g., 3,000 gallons per minute or higher).

The flow control device 1250 passively induces a constrained helical or spiral flow throughout the reaction chamber 1205 and maintains the spacing between electrodes 1240. In one example, the flow control device 1250 includes one or more non-conductive rails that are circumvoluted between the electrodes 1240 to produce a helical flow that increases contact between the fluid and the electrodes 1240 while also insulating adjacent electrodes 1240. For example, the non-conductive rails may be affixed between the anode electrode and the cathode electrode(s) in a corkscrew shape to induce turbulence and produce a helical flow of the fluid between the inlet port 1225 and the outlet port 1230. The non-conductive rails can also prevent adjacent electrodes 1240 from shifting into contact with one another under high flow rates. In some embodiments, a venturi device may be positioned in the reaction chamber 1205 to cause additional circulation of fluid (e.g., raw water, or at least partially treated water) through the electrodes 1240.

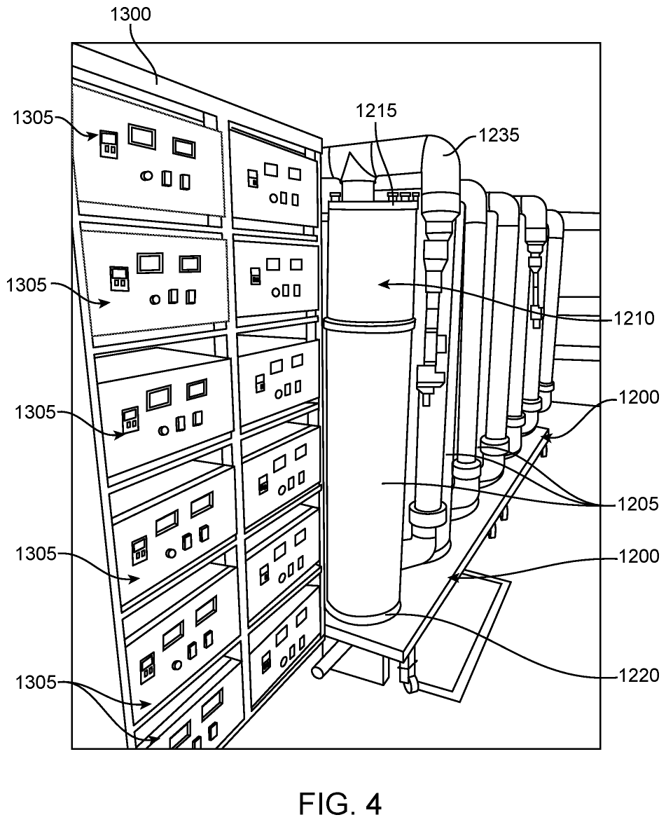

With reference to FIGS. 4 and 7A, power is supplied to the electrodes 1240 by a power distribution system 1300 that is electrically connected to the power posts 1245. The power distribution system 1300 includes a power source, one or more rectifiers 1305, a positive or cathode bus bar 1310 (e.g., formed of uncoated high-grade copper, such as Grade 1) that connects to the cathode electrodes via corresponding power posts 1245, and a negative or anode bus bar 1315 (e.g., formed of uncoated high-grade copper, such as Grade 1) that connects to the anode electrodes. The cathode bus bar 1310 is electrically connected (e.g., bolted) to the cathode electrode posts, and the anode bus bar 1315 is electrically connected (e.g., bolted) to the anode electrode posts. Power is supplied to the electrodes 1240 through the bus bars 1310, 1315 by the rectifier 1305, which is connected between the posts 1245 of the two largest (e.g., electrodes 1240 (i.e. the outermost anode electrode 1240 and the outermost cathode electrode 1240).

Returning to FIG. 1, water treated in the reaction chambers 1205 flows through the outlet lines 1115 to the mix vessel 1405. The illustrated mix vessel 1405 has a raw water inlet 1410 located at a first end 1415 of the mix vessel 1405, a plurality of activated water inlets 1420, a treated water recirculation outlet 1425 located at a second end 1430 of the mix vessel 1405, and a treated water storage outlet 1435 at the second end 1430 of the mix vessel 1405. For example, the activated water inlets 1420 may include one or more jet ports. The jet port is connected to a perforated pipe that extends between the first end 1415 and the second end 1430 across the mix vessel 1405 (e.g., located approximately halfway up the height of the vessel). Activated water inlets 1420 also may include access ports that are located on top of the mix vessel 1405 and that are connected to respective jet lines. Each jet line connects to a header that is attached to the outlet lines 1115. The jet lines circulate raw water with circulated (at least partially treated) water and to provide reaction kinetics for disinfection and transformation of the fluid in the mix vessel 1405.

The loop reactor 1400 includes a series of pumps (e.g., pump assemblies 1440, 1445), pipes, and valves to circulate raw and treated water through the fluid treatment system 1000. For example, the first pump assembly 1440 moves raw water to the mix vessel 1405 through a raw water inlet line 1413, and the second pump assembly 1445 circulates raw water or at least partially treated water to the treatment unit 1100 from the mix vessel 1405 through a recirculation line 1450. The third pump assembly 1455 moves treated water to the downstream location 1001 for storage via a storage line 1460. A valve at the raw water inlet 1410 controls the flow and flow rate of raw water to the mix vessel 1405. A valve at the recirculation outlet 1425 controls the flow and flow rate of fluid through the recirculation line 1450. A valve at the treated water storage outlet 1435 controls the flow and flow rate of treated water through the storage line 1460. Each valve can be controlled independently to adjust the flow rate into or out of the mix vessel 1405, or both into and out of the vessel 1405. In one example, the valve that is connected to the recirculation line 1450 may be set at a higher flow rate than the valve that is connected to the storage line 1460 from the mix vessel 1405 (e.g., to promote a larger amount of fluid circulated or recirculated to the treatment unit 1100 relative to the amount of fluid flowing to the downstream location 1001.

In some embodiments, treatment of raw water includes multiple steps. For example, in step 1, the loop reactor 1400 charges the treatment unit 1100 by filling the mix vessel 1405 with raw water and closing the valve to the raw water inlet 1410, closing the valve at the treated water storage outlet 1435, opening the valve to the treated water recirculation line 1450, and initiating flow of fluid between the mixing and pre-reaction vessel 1405 and the treatment unit 1100 via the second pump assembly 1445. In step 2, the raw water is circulated, and recirculated if necessary, through the loop reactor 1400 until treatment parameters for the fluid have been reached. Stated another way, the fluid in the loop reactor 1400 in step 2 has reached a stage where the treatment parameters have been met or exceeded. In step 3, the valve on the raw water inlet 1410 is opened to permit flow of additional raw water into the loop reactor 1400, while activated or treated water enters the mixing and pre-reaction vessel 1405 at different points (e.g., at the same, or substantially the same, flow rate) via the jet lines. Each of the flow rates can be adjusted to maintain treatment parameters for the fluid. For example, the supply of activated water entering the mixing and pre-reaction vessel 1405 may be adjusted via one or more valves (e.g., on the recirculation line 1450, the second pump assembly 1445, the jet lines, and/or adjusting the current provided to the electrodes 1240) to achieve desired treatment parameters in the mix vessel 1405.

The jet lines facilitate high velocity mixing of the activated water with raw water over the length of the mixing and pre-reaction vessel 1405 That is, the jet lines provide higher treatment success due to high-velocity mixing of microbubbles in the activated water. As the activated water moves through the loop reactor 1400, reactions between the activated water and the raw water occur in a two-phase (liquid-gas) environment. The microbubbles produced by the jet lines promote an increase in mixing and turbulence. These microbubbles also increase the gas-liquid contact through increased surface area created by the microbubbles. By the time the fluid in the mixing and pre-reaction vessel 1405 reaches the second end 1430, the previously raw water that entered the vessel 1405 at the first end 1415 has transformed to treated water. The water at the second end 1430 is then directed through the treated water storage outlet 1435 (for storage or immediate use), as well as through the recirculation line 1450 to continue the treatment process for additional raw water entering the mix vessel 1405. The relative flow through the treated water storage outlet 1435 and the recirculation line 1450 is controlled to maintain adequate treatment conditions in the loop reactor 1400 for the additional raw water entering the mix vessel 1405 via the inlet line 1413.

The treatment standards for the fluid being treated are maintained by adjusting the flow rate of the raw water entering the system 1000 through the raw water inlet line 1413 and adjusting the flow rate of treated water exiting the system through the treated water storage outlet 1435 via valves and the pump assemblies 1440, 1445.

In operation, the electrodes 1240 produce activated water through electrochemistry and advanced molecular oxidation in the reaction chambers 1205. Raw water enters each reaction chamber 1205 and is forced upward toward the outlet port 1230 via the flow control device 1250 and the pressure provided by the second pump assembly 1445. As the raw water flows upward through the reaction chamber 1205, the water directly contacts the non-donating electrodes 1240. The rectifier 1250 controls high voltage ripple and power fluctuations, configures loads, and includes capacitive, inductive, and resistive characteristics. The rectifier 1250 distributes current equally to each of the electrodes 1240 in the reaction chamber 1205 and has a positive and ground connection to each electrode 1240 in the correct phase. The copper bus bars 1310, 1315 and the location of the power supply rectifier 1250 minimize resistive heat generation, which allows sustained usage of the fluid treatment system 1000 at high amperages. In the illustrated example, each rectifier 1305 is electrically coupled to two reaction chambers 1205.

The powered, non-donating electrodes 1240 force reduction-oxidation reactions that breakdown and neutralize contaminants. More specifically, electrons are supplied by the negatively charged electrodes (anodes) to the contaminants, which molecularly transform contaminants within the fluid solution to their elemental states or neutral molecules. Other contaminants within the fluid give up their electrons when they contact the cathode electrodes, which produces oxidized compounds, ions, or molecules. The non-donating electrodes facilitate electron transfer without dissolving the electrodes.

The loop reactor 1400 provides both process control advantages and chemical advantages. The mixing and pre-reactor vessel 1405 provides process management to the loop reactor 1400 in multiple ways. First, the mixing and pre-reactor vessel 1405 buffers pressure changes in the reaction chambers 1205 to provide uniform feed concentrations and consistent flow rates of activated water. More specifically, the jet lines at the activated water inlet ports 1420 mix raw water with activated water from the reactors 1205 to provide consistent, uniform pressure to the recirculation line 1450. Furthermore, raw water mixes with the activated water flowing from the reaction chambers 1205, which facilitates pre-reaction (e.g., pretreatment) and activation of incoming contaminated species as well as extended contact time for slower kinetics of some contaminate species in the activated water. The raw fluid flows through the reaction chambers 1205 of the treatment unit 1100 until treatment parameters for the water have been reached. The treatment parameters vary based on the raw water being treated and the desired state of the activated water.

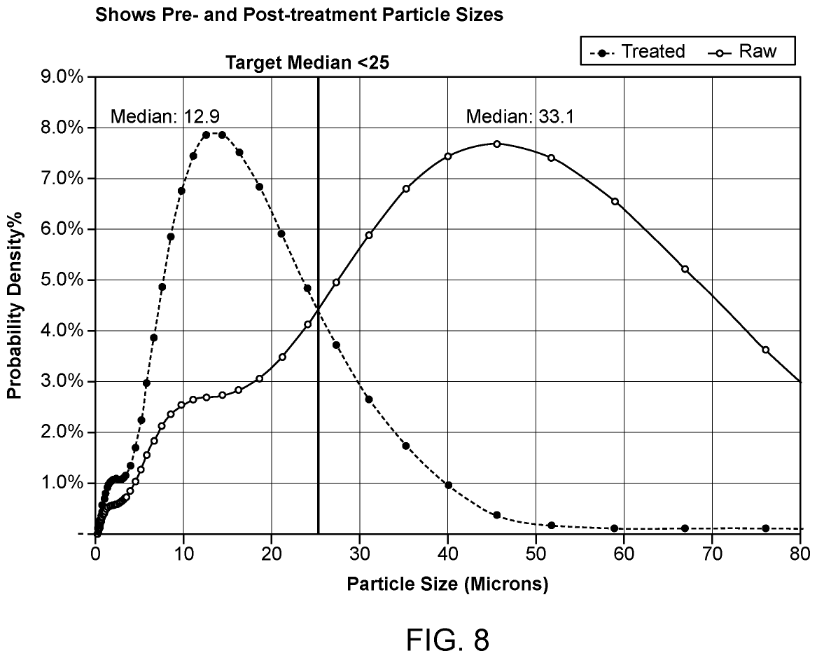

FIGS. 8-13 show various properties of water treated with the above described fluid treatment system 1000. Specifically, FIG. 8 compares the median particle size of a water sample treated by the fluid treatment system 1000 and produced water (raw water). In water treatment, particle size distribution represents pollutant concentrations and serves an indicator of water quality. Particle size distribution expresses the size of particles present in a fluid and the proportion particle sizes present in a fluid. Measurement techniques for particle size distribution include laser diffraction, and dynamic image analysis. FIG. 8 shows a median particle size, measured in microns, of water treated in the fluid treatment system 1000 compared to untreated or produced water. As shown in FIG. 8, the median particle size in water treated by the fluid treatment system 1000 is 12.9 microns, while the median particle size in produced water is 33.1 microns. The reduction in median particle size in the water treated by the above described fluid treatment system 1000 indicated reduced levels of contaminants.

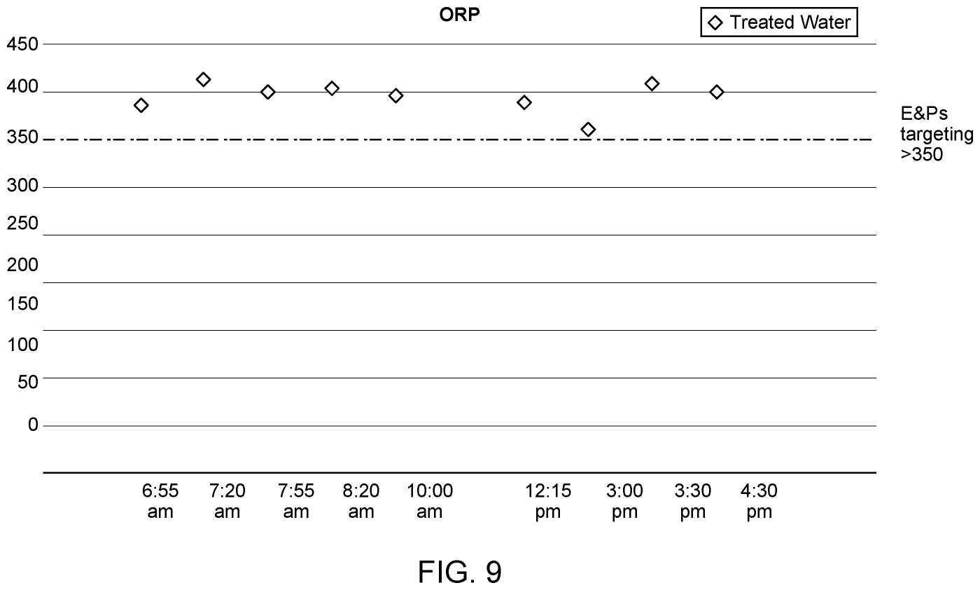

FIG. 9 shows the oxidation reduction potential (ORP) of a water sample treated by the above-described fluid treatment system 1000 over an 8-hour period. In water treatment, ORP serves as an indicator of water quality and the capacity of the water to stay clean. As shown in FIG. 9, the water sample treated by the fluid treatment system 1000 sustained ORP values above 350 mV over an 8-hour time frame. ORP values are measured with an ORP probe, which measures electron activity within water. In the treated water sample of FIG. 9, ORP values were measured with a HACH HQ40d sensor and a HACH DRD1P5 sensor. Sustained ORP values greater than 350 mV in the treated water sample show indicated improved water quality by the fluid treatment system 1000.

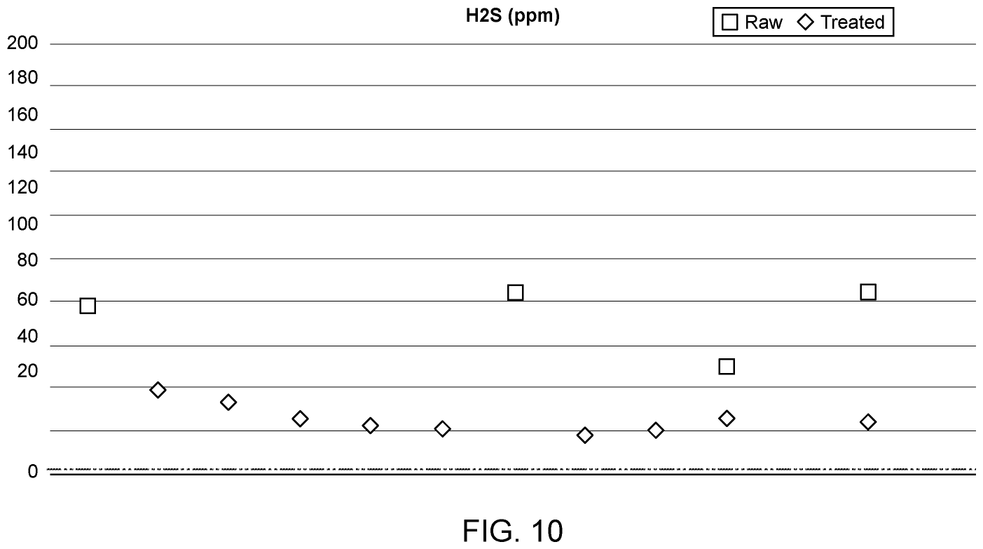

The chart in FIG. 10 illustrates hydrogen sulfide (H2S) levels (e.g. contaminant levels measured in parts per million) of a water sample treated in the fluid treatment system 1000 compared to produced water. As shown in FIG. 10, the water treated by the fluid treatment system 1000 had a maximum H2S value of approximately 18 ppm. The untreated, or produced water had a maximum H2S value of approximately 65 ppm. The reduction of H2S values in the water sample treated by the fluid treatment system 1000 also indicated improved water quality.

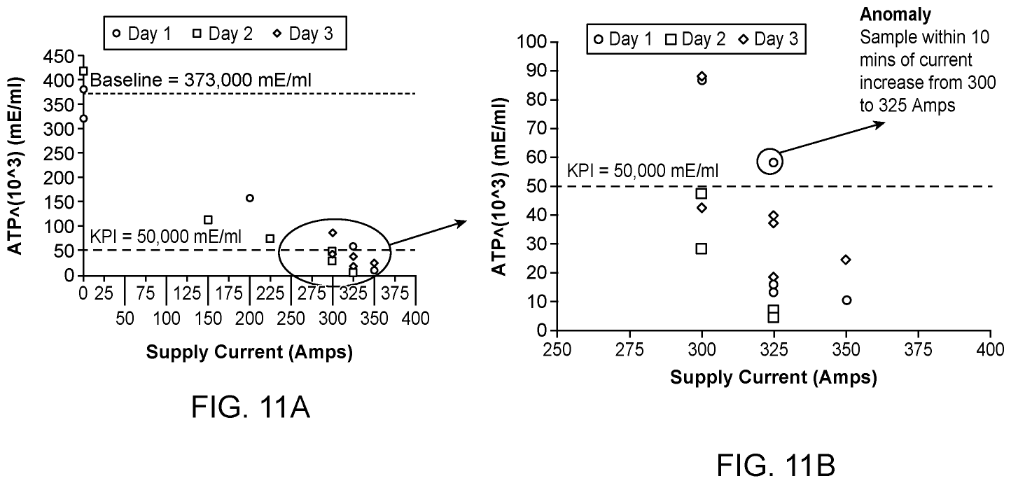

FIG. 11A is a chart illustrating results of an adenosine triphosphate (ATP) test of a water sample treated in the fluid treatment system 1000 before and after treatment, over a three-day period. The ATP test indicates bacteria levels in water. FIG. 11B illustrates an enlargement of a portion of the FIG. 11A chart between 250 Amps and 400 Amps. As shown in FIG. 11A, the untreated water sample had an ATP value of 373,000 mE/ml. After treatment in the fluid treatment system 1000, the water sample had ATP values less than 50,000 mE/ml when the current was greater than 325 Amps. ATP values in the water sample were measured with the Hygiena Monitoring System and the LuminUltra Photonmaster. The charts in FIGS. 11A and 11B show a reduction in bacteria and microorganisms in the water sample after treatment in the fluid system treatment 1000.

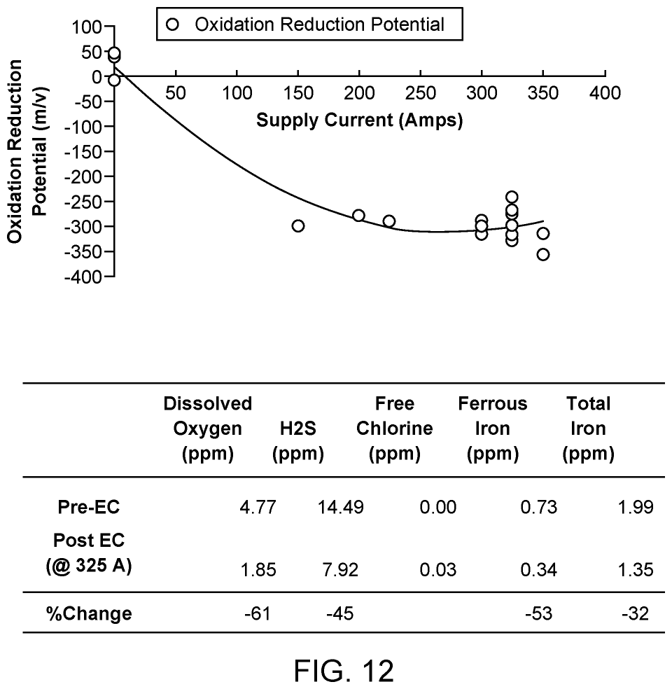

FIG. 12 is a chart illustrating the results of a corrosion test on a sample of water treated by the fluid treatment system 1000. As shown, the sample of water treated by the fluid treatment system 1000 had reduced levels of contaminants such as H2S ferrous iron. The chart in FIG. 12A also shows a free chlorine value less than 0.3 mg/l. Free chlorine in the treated water sample was measured using the Hach DR3900 Laboratory Spectrophotometer for water analysis The free chlorine value in the treated water was less than 1.0 mg/l and indicated that the water treated by the fluid treatment system 1000 is non-corrosive.

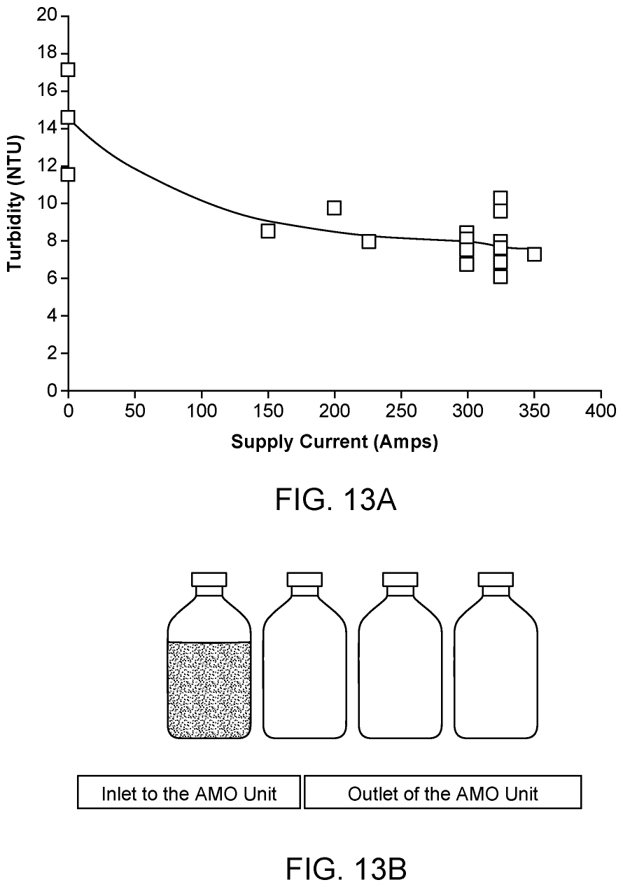

The chart shown in FIG. 13A illustrates the results of a turbidity and geochemistry test on a water sample before and after treatment by the fluid treatment system 1000 over three days. The turbidity test described the cloudiness of the water. High turbidity is associated with very cloudy water, and low turbidity is associated with clear water. FIG. 13B is a side view of a sample of water before, during, and after treatment in the fluid treatment system 1000. FIG. 13B is a visual representation of the turbidity values in FIG. 13A. FIGS. 13A and 13B show reduced turbidity in the water sample treated by the fluid treatment system 1000.

In one arrangement of the fluid treatment system for water wells, the system may take the form of an in-line system. The in-line treatment system includes a single reaction chamber that is open-ended and generally the size of the well casing. The reaction chamber can be five to forty feet in length and can slide into the well casing. The electrodes are formed as sets of curved disks or plates that are mounted to the sides of the reaction chamber. Each electrode is powered through the side of the reaction chamber. Water treatment occurs as the water moves up through the well and comes in contact with the sets of electrodes in the reaction chamber.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. For example, although the invention is described and illustrated herein with reference to a deli-style merchandiser, other types of merchandisers or display cases can utilize aspects of the invention described, illustrated, and recited herein. Also, any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments.

1. A fluid activation system comprising:
an inlet line configured to receive raw water;
a pump fluidly coupled to the inlet line to generate a flow through the inlet line;
a vessel fluidly coupled to the inlet line and including a reaction chamber having a flow control device and non-donating electrodes disposed inside the reaction chamber, the non-donating electrodes defining at least one cathode electrode and at least one anode electrode configured to treat the raw water to produce treated water, and each of the non-donating electrodes including an electrode post;
an outlet line in fluid connection with the vessel; and
a power distribution system electrically connected to the electrode posts to power the non-donating electrodes.

2. The fluid activation system of claim 1, wherein the flow control device is configured to generate a passive spiral flow of water through the reaction chamber.

3. The fluid activation system of claim 2, wherein the flow control device includes a non-conductive rail that is circumvoluted between the at least one anode electrode and the at least one cathode electrode in a corkscrew shape, thereby producing a helical flow of the raw water traveling through the reaction chamber.

4. The fluid activation system of claim 2, wherein the flow control device maintains space and is positioned between adjacent non-donating electrodes.

5. The fluid activation system of claim 2, wherein the flow control device is composed of a non-conductive material.

6. The fluid activation system of claim 1, wherein the reaction chamber is a first reaction chamber fluidly connected to the inlet line, wherein the fluid activation system further includes a second reaction chamber that is separate from the first reaction chamber and fluidly connected to the outlet line, and a plurality of third reaction chambers that are serially connected between the first and second reaction chambers.

7. The fluid activation system of claim 1, wherein the reaction chamber includes a housing, a cover, a base disposed at an opposite side of the housing relative to the cover, an inlet port that is fluidly connected to the inlet line and disposed adjacent the base, and an outlet port fluidly connected to the outlet line and disposed adjacent the cover.

8. The fluid activation system of claim 7, wherein the non-donating electrodes are each electrically connected to the electrode post, wherein each electrode post extends through the cover and transfers an electrical current from the power distribution system to the corresponding non-donating electrodes.

9. The fluid activation system of claim 1, wherein the non-donating electrodes are tubular in shape and formed of a metallic mesh material.

10. The fluid activation system of claim 1, wherein the non-donating electrodes are concentrically arranged within the reaction chamber such that an outermost non-donating electrode of the non-donating electrodes defines a first surface area and an innermost electrode of the non-donating electrodes defines a second surface area that is less than the first surface area.

11. A method of circulating raw water through a fluid activation system to produce treated water, the method comprising:
pumping the raw water from a water source to a mix vessel via a first pump assembly;
activating the raw water in a reaction chamber including a flow control device and non-donating electrodes disposed inside the reaction chamber to produce treated water via electrochemistry;
pumping the treated water from the reaction chamber back to the mix vessel via a second pump assembly;
mixing the treated water and additional raw water at a first end of the mix vessel under a two-phase liquid-gas environment, such that a mixture of the treated water and the additional raw water becomes treated water at a second end of the mix vessel; and
thereafter discharging the treated water out of the second end of the mix vessel to a storage container via a third pump assembly.

12. The method of claim 11, further comprising providing a non-conductive rail on the flow control device that is circumvoluted between the non-donating electrodes in a corkscrew shape, wherein the non-donating electrodes are concentrically disposed relative to each other.

13. The method of claim 11, wherein the step of activating the raw water in the reaction chamber includes supplying an electrical current through the non-donating electrodes and inducing a helical flow of the raw water within the reaction chamber that passes through the non-donating electrodes via the flow control device.

14. The method of claim 11, further comprising recirculating the mixture within the mix vessel through the reaction chamber a second time via the second pump assembly to further activate the mixture.

15. The method of claim 11, wherein the step of mixing the treated water and the additional raw water includes introducing the treated water into the mix vessel via high-velocity jet lines, creating microbubbles through the mixture, and transforming the mixture to treated water.
